(19) United States
(12) Patent Application Publication
(10) Pub. No.: US 2013/0212118 A1
(43) Pub. Date: Aug. 15, 2013

(54) SYSTEM FOR MANAGING LITIGATION HISTORY AND METHODS THEREOF

(71) Applicants: James M. KING, Phoenix, AZ (US); Richard T. RUYLE, Phoenix, AZ (US)

(72) Inventors: James M. KING, Phoenix, AZ (US); Richard T. RUYLE, Phoenix, AZ (US)

(21) Appl. No.: 13/371,775

(22) Filed: Feb. 13, 2012

(51) Int. Cl. G06F 17/30; G06F 7/00

(52) U.S. Cl. 707/758; 707/812; 707/E17.01; 707/E17.008

(57) ABSTRACT

The present disclosure is generally directed to a system and method for managing and querying historical document use within a litigation history. In one illustrative embodiment, each document used in any litigation case for a specific client, corporation or individual can be included in a historical database for that client, corporation or individual. If, and when a document is tagged, redacted or produced, the history for that document can be updated with case information. A link can be provided that would enable the user to return back to the original case database. Each document can be identified by a hash value that allows efficient tracking of the same document throughout the litigation history of the client.

### TECHNICAL FIELD

This disclosure generally relates to documents, and more particularly, to managing documents within a corporate litigation history.

### BACKGROUND

Modern electronic and optical data storage systems store vast amounts of information, far more than ever possible using conventional paper and ink. Current storage media can contain more information than can be contained in a file cabinet full of documents. The information on an electronic or optical medium is also easy to access and organize using databases and search systems. Nonetheless, paper persists as a common medium. In many cases, the storage and indexing issues associated with paper documents are tolerated in view of paper's familiarity and simplicity. Such documents accumulate over time into large collections of paper and files.

In complex litigation cases, documents having the information can be stored, transported, sorted, and/or reviewed. Converting the paper to opto-electronic form for transport, storage, indexing and retrieval can involve feeding each document through a scanner, which makes an electronic image of the document and stores it. The image can then be withdrawn from data storage at a later time for review, printing or organization.

Processes for making and organizing images of documents tend to be complex and difficult. Generally, scanning large volumes of documents has required a system administrator or other relatively high-ranking individual to set up a scanning project and assign the project to a scanning operator. The scanning operator, who is ordinarily a trained operator, scans the documents, which creates a series of electronic images of the documents. The administrator then can assign the project to a quality-control operator, who then reviews the images to ensure that they are accurate and complete. Finally, to generate hard copies of the documents, the electronic documents can be assigned reference numbers to be inserted into the electronic images, and then printed and reassembled.

Increasingly, electronic documents placed within repositories can be manipulated or changed throughout the course of a case. Preservation of the changes and iterations to these documents can be important when reviewing the case. Furthermore, a number of lawyers can also be involved with changes or drafts to the case. When changes are entered, current document systems do not retain identifiers indicating which lawyer made those changes. Systems further fail to fully utilize electronic documents which are relevant to a current case even though there is no association between them. Case law, etc. would have to be developed in each case separately. Conflicts should also be handled through the system.

By way of example, in an entities litigation history, the same documents are reviewed multiple times in different litigations. The review of documents is costly in terms of both money and time. Currently, each review is an isolated instance and the same collected documents are reviewed again and again as if they are new and have never been reviewed by an attorney prior to the case. The more history of litigation, the more times those same documents are reviewed in separate instances. Each new case contains a larger document collection as new corporate communications are added over time, increasing the cost and the time to review. If a document is reviewed once and the status of the document is known, that is, responsive, privileged, confidential, etc., there is a very likely chance that the same status applies to a new case, thereby eliminating the need to be looked at again during the course of future litigation. As time goes on, the collection of documents that need review becomes smaller instead of larger, since the majority of those documents have been reviewed during the past and assessed as to their disposition. The ability to solve these issues is missing in the status quo.

A need therefore exists for a historical document system and methods thereof that overcome those issues described above. These, as well as other related advantages, will be described in the present disclosure.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a case management system is provided. The system can include a database storing historical and custodial information of a plurality of documents through configurable hashes. The configurable hashes can be linked with the plurality of documents within a case database.

In accordance with another aspect of the present disclosure, a method for managing a plurality of documents through a historical database is provided. The method can include receiving a document, creating a hash for the document, searching for the hash within the historical database, and updating custodial and historical information for the document within the historical database when the hash is found, otherwise, adding the hash into the historical database and associating the hash with the custodial and historical information.

In accordance with yet another aspect of the present disclosure, a case management server is provided. The server can include at least one processor and a memory operatively coupled to the processor, the memory storing program instructions that when executed by the processor, causes the processor to perform procedures. The procedures can include storing historical and custodial information for a plurality of documents within a historical database along with hashes of the plurality of documents, storing the plurality of documents within a case database and linking the hashes within the historical database to the plurality of documents within the case database.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a block diagram illustrating an exemplary system for providing historical and custodial information in accordance with one or more aspects of the present disclosure;

FIG. 2 is a block diagram of a typical server within the system in accordance with one or more aspects of the present disclosure;

FIG. 3 is a flow chart depicting illustrative processes for managing workflow production history in accordance with one or more aspects of the present disclosure;

FIG. 4 is a flow chart depicting illustrative processes for native file ingestion in accordance with one or more aspects of the present disclosure;

FIG. 5 is a flow chart depicting illustrative processes for load file imports in accordance with one or more aspects of the present disclosure;

FIG. 6 is a flow chart depicting illustrative processes for batch reviews in accordance with one or more aspects of the present disclosure;

FIG. 7 is a flow chart depicting illustrative processes for history updates in accordance with one or more aspects of the present disclosure;

FIG. 8 is a flow chart depicting illustrative processes for document history database queries in accordance with one or more aspects of the present disclosure;

FIG. 9 is a flow chart depicting illustrative processes for removing production conflicts in accordance with one or more aspects of the present disclosure; and

FIG. 10 is a flow chart depicting illustrative processes for production history updates in accordance with one or more aspects of the present disclosure.

### DESCRIPTION OF THE DISCLOSURE

The description set forth below in connection with the appended drawings is intended as a description of presently preferred embodiments of the disclosure and is not intended to represent the only foams in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the present disclosure is directed to a system and method for managing historical documents within a litigation history. The present disclosure describes the system and method, by way of non-limiting example only, with particular applicability to litigation documents such as pleadings, depositions, briefs, memorandum, etc., which are also referred to herein as documents. In one illustrative embodiment, information about each document used in a litigation case for a specific client, corporation or individual can be stored in a historical database. If, and when a document is tagged, redacted or produced, the history for that document can be updated with case information. A link can be provided that can enable the user to return back to the original case database. Each document can be identified by a hash value that allows efficient tracking of the same document throughout the litigation history of the client, corporation or individual.

A number of advantages can be provided through the historical document system. The disclosed system and method makes it possible for documents as well as their historical and custodial information to be delivered in seconds via the Internet, instead of days through the use of the current standard couriers, such as “snail” mail Using the disclosed system, vital documents not only reach their destination more quickly but also in a more cost-effective manner. The historical and custodial information of any document in the system can be queried and returned. Furthermore, how the documents were used in any and all cases where it was part of the collected document can be provided. The insertion, updating and querying of the database can be performed through application programming interfaces (APIs) that can allow access from a local or remote location or application.

Serial litigants can benefit from the system and method described herein as the time to review documents involved in a litigation history can diminish immensely over the years, which directly correlates to significantly lower costs and the enhanced ability for an entity to properly defend itself. A historical document disposition in similar type litigations can present a reasonable effort in determining whether a document should be produced, held or ignored as non-responsive. Furthermore, irrelevant documents can be teased out of the system. Other advantages will become apparent from the discussion provided below.

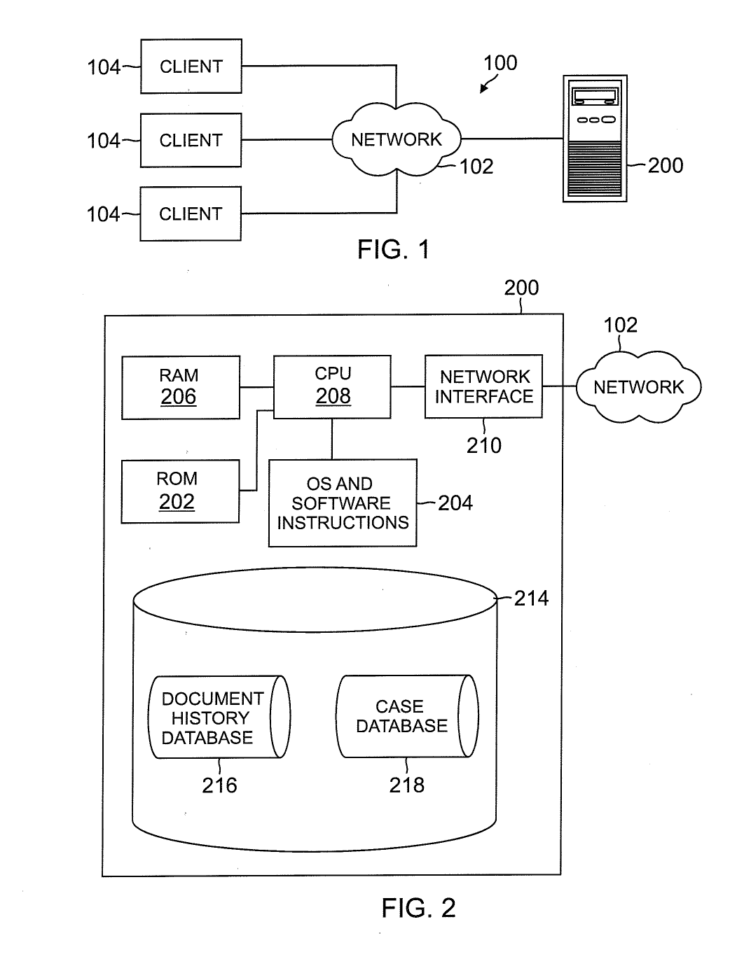

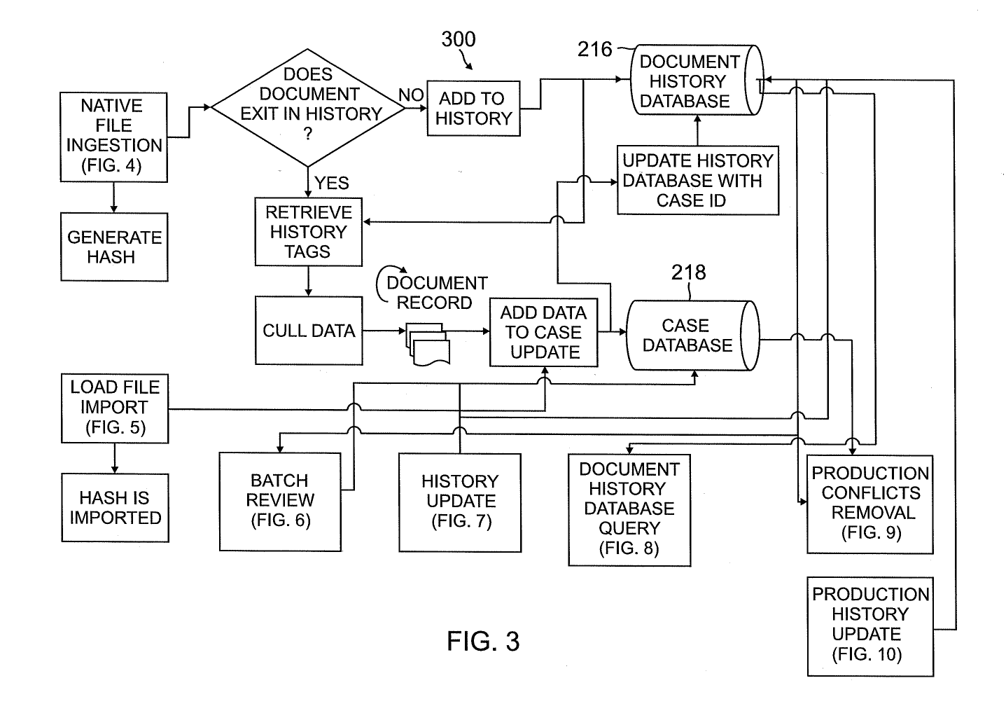

An exemplary environment for the historical document system will be described in FIGS. 1 and 2. FIGS. 3 through 10 will provide exemplary procedures for managing historical and custodial information. The system for managing litigation history can be referred to a number of terms. For example, the system can be referred to as a case management system or server. A variety of terms will be used and uses of these terms will become apparent from the following description.

Incorporated into those features described herein is predictive coding. By way of a non-limiting example, predictive coding can automate the process in which documents can be tagged and reviewed. Predictive coding is the electronic coding, organization and prioritization of entire sets of electronically stored information (ESI) according to their relation to discovery responsiveness, privilege, and designated issues before and during the legal discovery process. Typically, lawyers or the like can control this process by specifying relevant criteria. Computers or similar devices can then expedite discovery.

A document, for purposes of the present disclosure, can be a file stored on a computer readable medium. The document can be stored in an electronic foam otherwise known as an electronic document. These documents can be viewed on a screen associated with a computing device or the like. Multiple file formats are encompassed within the present disclosure with conversions of these formats capable among different clients.

Historical information of the document can include, but is not necessarily limited to, how the document was used in the past. By way of a non-limiting example, the way that the document was ingested, tagged and produced can be noted within the historical information of a document. Other relevant records of the document can be kept within the historical information. For example, custodial information can refer to which party handled or has used the particular document. Furthermore, present information such as who is currently using the document can also be kept tracked of. The historical and custodial information can be kept separate from the document itself, but does not necessarily have to.

Turning now to FIG. 1, a block diagram illustrating an exemplary system 100 for providing historical and custodial information in accordance with one or more aspects of the present disclosure is shown. The system 100 makes it possible for documents along with its historical and custodial information to be delivered in seconds via the Internet or other network 102. According to the present system 100 and method, each document can be associated with two major components: 1) the document itself, and 2) historical and custodial information. As will be shown, each of these components can be stored in separate databases.

As documents are added by clients 104 to a case database that is linked to the document history system 100, a hash from a document can be checked against a history database. If the hash exists, the history database for that document can be updated with this case identification. When the document does not exist in the history database, it can be added and updated. If no hash exists, a hash can be created from the full text of the document, which can be performed by distributed agent software.

A number of clients 104 can operate on appropriate computing devices. These devices can include desktop computers, personal computers, laptop computers, personal digital assistants (PDA), smartphones, cellular phones, tablets and dedicated or non-dedicated interfaces, to name a few. Each of the clients 104 can include hardware and software capable of communicating with the server 200. Clients 104 can be located at a number of locations and are generally not directly tied to the network 102. Wireless access points can be used such that the clients 104 can communicate wirelessly through a network 102 to the server 200. Carrier services, as well as WiFi® or Bluetooth™, can also be implemented to receive and transmit data to and from the server 200. Wireline implementations can also be incorporated.

Shown within FIG. 1, the client 104 operating on the device can interact with the server 200 through a network 102. The network 102, by way of a non-limiting example, can be on one or more local area networks (LANs). The LAN can include a computer network 102 covering a small physical area, typically located within a home, office, or small group of buildings. Other networks 102 can also include a wireless access network (WAN), personal area network (PAN), controller area network (CAN), metropolitan area network (MAN) or global area network (GAN). Those skilled in the relevant art will appreciate that a combination of these networks can be used and is not wholly limited to a single network 102.

As shown in FIG. 1, the server 200 can be accessed through the Internet or World Wide Web (WWW), in some instances as a web site. Additionally, while it is recognized that there is a technological distinction between the Internet and WWW, the terms are seemingly interchangeable and used as such throughout this disclosure. The use of these terms in this fashion is for descriptive convenience only. The skilled artisan will appreciate that the system 100 encompasses the technological context of both the Internet and the WWW.

A peer-to-peer (P2P) network, which can be implemented within the system 100, can control the flow of documents and information across the system 100 and ensure that the documents are only transmitted to valid clients 104. The security features of the disclosed system 100 and method can maintain a secure end-to-end system 100. User authentication can employ various techniques known in the art to verify various end users of the system 100.

FIG. 2 is a block diagram of a typical server 200 within the system 100 in accordance with one or more aspects of the present disclosure. The server 200 can take the form of a computer server, and more specifically a web server. The server 200 can process incoming document queries as well as managing those documents. The server 200 can include ROM 202, operating system and software instructions 204, RAM 206, central processor unit (CPU) 208, network interface 210 connected to the network 102 and data storage device 214. A conventional personal computer or computer workstation with sufficient memory and processing capabilities can be used as the server 200. Alternatively, multiple interconnected servers can also serve as the server 200.

The server 200 can be able to handle high volumes of transactions and large amount of queries for communication and data processing. RAM 206 and ROM 202 are used to support the program codes that are operated by the CPU 208. The memory can be in a form of a hard disk, CD ROM, or equivalent storage medium. The CPU 208 can support the authentications such as communications from external data servers, as well as allowing for anonymous transactions and general data encryption.

The data storage device 214 can include hard disk magnetic or optical storage units, as well as CD ROM, CD RW or DVD ROM and flash memory such as compact flash and secure digital cards. The data storage device 214 can contain databases used in the processing of transactions and storing information including a document history database 216 and case database 218. Data can flow from each of the databases 214 and 216 and can be interconnected through logical or physical connections.

The document history database 216 can store information for each document. For example, the information can include how a document was ingested, tagged, produced, etc. The document history database 216 typically does not store the document itself, which is stored in the case database 218. Configurable hashes can be first generated for incoming documents and stored within the database 216. The hashes are associated with the particular file stored in the case database 218. Configurable hashes can be made by a message-digest algorithm 5 (MD5) or secure hash algorithm 1 (SHA-1). Known to those skilled in the relevant art, other hashing algorithms can be used.

Predictive coding can be used to generate hashes. Predictive coding can place “fingerprints” on documents. Through the predictive coding, documents can be verified and quality control can be maintained by the system 100. In FIG. 2, the data storage device 214 is located on the server 200. The data storage device 214, or databases therein, can be outside the server 200. The databases 214 and 216 can be separated and be placed in a cloud service or through other type of system.

When documents are received, a number of tags can be associated with each document. Each case can have a unique case identification. The case identification can identify each document by matter used (or not used in). Tags can be assigned or removed by case identification. As they are assigned or removed in a case, the document history within the document history database 216 can be updated to reflect this. Production information, such as when a document is being produced, can be by case identification for each document. The system 100 can update the document history database 216 and case database 218 when a document is produced, for example, by adding a date to the document. Custodial information can also be kept tracked of in the document history database 216. All of the above can be queried by any of the fielded information, custodian, case, tag, production, etc. A variety of different criteria can be used and is not limited to those disclosed herein. The history document database 216 can be stored in a relational database allowing for robust filtering and querying.

A separate permissions database can also be incorporated within the data storage device 214, not shown. The permissions database can keep track of clients 104 operating on computing devices and permissions given to each. Varying levels of permissions and authorizations can be provided through the permissions database. By way of a non-limiting example, documents within the case database 218 can have different access authorizations which can be managed by the permissions database for supervisors versus management leads.

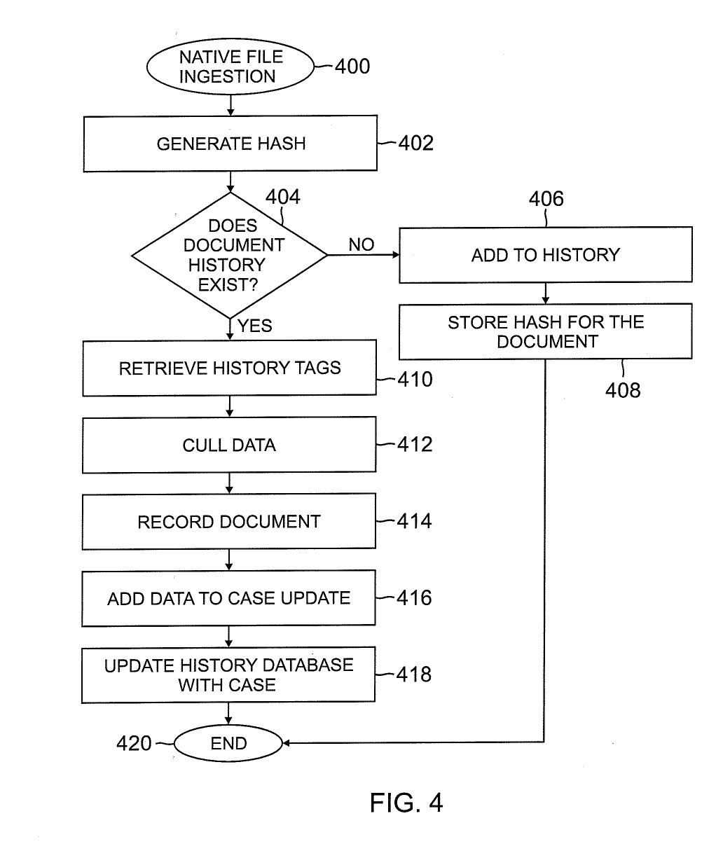

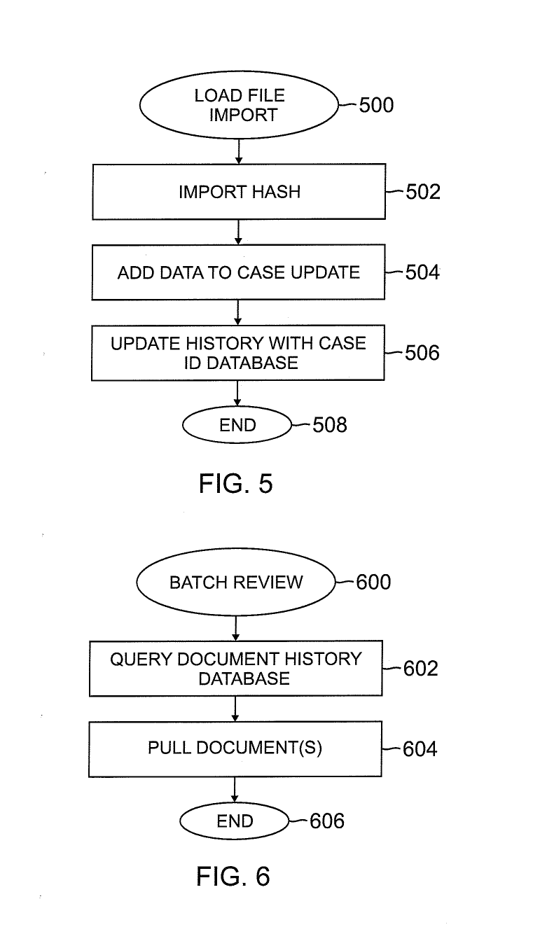

Referring to FIG. 3, a flow chart depicting illustrative processes for managing workflow production history in accordance with one or more aspects of the present disclosure is shown. The workflow 300 shows multiple ways for receiving a document. Documents can be incorporated through native file ingestion, which will be shown in FIG. 4. FIG. 5 will show processes for importing load files. The document history database 216 and case database 218, described above, can be incorporated into the workflow 300. The document history database 216 can hold each unique document based on a configurable hash option. The hash can include, but is not limited to, MD5 or SHA-1. Tags can be assigned to each document and be referenced in both the document history database 216 and case database 218. Other document receiving techniques can be incorporated into the workflow 300.

Within the document history database 216, information about how the document was used in the past can be stored. As documents are imported or ingested, the document history database 216 can be updated to reflect the status. Ingestion tools can also query for document history and update tags within the ingestion applications if they exist. When documents are updated or redacted, tags associated with the documents can be reflected in real-time in the document history database 216.

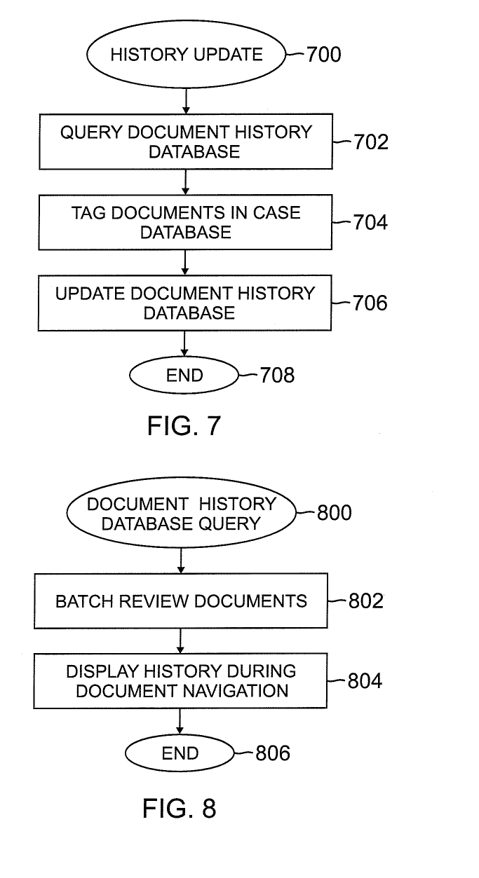

Through the workflow 300, data can be pulled out for each document. In FIG. 6, the document history database can be queried to batch review documents. Documents can be batched for review by document history filtered criteria, for example, all documents marked privileged in any prior case. The batch review can be performed by looking up previous tags assigned to the documents as well as information within the document history database 216. Documents can be tagged in real-time with a history update as will be shown in FIG. 7. FIG. 8 will show advance querying of a document's history and custodial history for litigation by case type. History can also be kept track of by case type, which is assigned and configured when the cases are created. During case review, cases linked to the document history database 216 can query the history for documents and display how it was used in any, some or all of the cases that the document can have existed within. The original case does not need to be online or available to display the history. Document processing software can query the history document database 216 as well to identify and/or pre-tag documents that have been used in previous litigation cases.

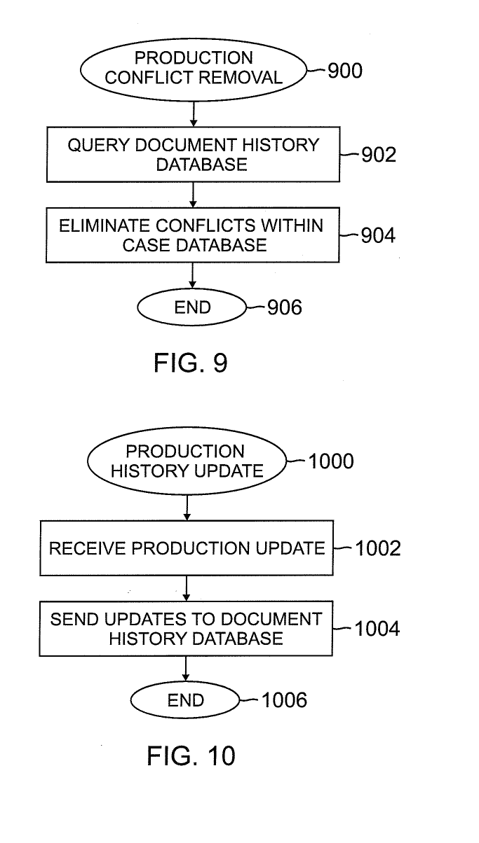

The history during document navigation can be displayed and used for production and redaction conflict identification as will be shown in FIG. 9. Statistical quality control or final conflict check can be performed to identify documents within one case or the current case that can have conflicting use in prior cases. Production history can be updated as will be shown in FIG. 10. The document history database 216 can be used to identify custodians whose documents were collected in the past but never used as well as custodians most often relevant to cases. This can be performed through predictive coding.

Documents can be received through a number of processes, which can include native file ingestion and load file import. FIG. 4 is a flow chart depicting illustrative processes for native file ingestion in accordance with one or more aspects of the present disclosure. The processes for file ingestion can begin at block 400. At block 402, a hash can be created for the document being received. At decision block 404, the server 200 can determine if the generated hash for the document exists in the document history database 216.

When no hash exists for the document, or it cannot be found, a history file can be created to reflect ingestion for this specific case and added to the document history database 216 at block 406. The hash can be stored at block 408 for future reference. The processes can end at block 420. If the document history exists within the document history database 216, at block 410, the server 200 can retrieve history tags form the document history database 216. Through the history tags, data can be culled at block 412. Documents can be recorded at block 414. The culled data can be added to the case database 218 at block 416 through a case update function. The document history can be updated for each document to reflect the addition of the document to the review process for this particular case at block 418. The history can be updated to reflect ingestion for this specific case. The processes can end at block 420.

Turning to FIG. 5, a flow chart depicting illustrative processes for load file imports in accordance with one or more aspects of the present disclosure is shown. The processes can often times be similar to those described for native file ingestion such that the same modules can be re-used by each process as shown in the workflow 300 of FIG. 3. The processes can begin at block 500. At block 502, a hash of the document being can be imported. The data can be added to the case database 218 at block 504 through a case update function. The document history can be updated for each document to reflect the addition of the document to the review process for this particular case at block 506. The history can be updated to reflect ingestion for this specific case. The processes can end at block 508

During native file ingestion and load file import, documents can be queried to see if those files exist in the document history database 216. Tags can be associated with the documents during the file ingestion or import process. The case database 218 can hold the document information, while the document history database 216 can maintain only the history of the document. Each document can have a hash and that field is in both the document history database 216 and case database 218, and can be used as the primary key to link the documents within the databases 216 and 218. Documents can be tagged by reviewers in the case database 218. A matter or case identification can be associated with each document as well. Through tagging and identifying documents within the system 100, a number of features can be provided.

FIG. 6 is a flow chart depicting illustrative processes for batch reviews in accordance with one or more aspects of the present disclosure. The processes can begin at block 600. Initially, a user can make a request for documents that have related criteria, for example, a case number. By way of a non-limiting example, the user can have a client 104 on an associated device. The client 104 can provide a user interface to the user whereby the user can enter in criteria to query the document history database 216.

At block 602, a query can be provided to the document history database 216 to retrieve historical and custodial information for the documents corresponding to the entered criteria. For example, the user can enter in criteria to search for pleadings and briefs filed after Bilski v. Kappos, 130 S. Ct. 3218, 561 US ______, 177 L. Ed. 2d 792 (2010). The system 100 can then pull documents at block 604 relevant to the criteria and provide them to the user. At block 606, the processes can end.

FIG. 7 is a flow chart depicting illustrative processes for history updates in accordance with one or more aspects of the present disclosure. The processes can begin at block 700. Initially, a history update request can be made by a user through their client 104 operating on an associated device. At block 702, the server 200 after receiving the request, can query the document history database 216 for historical and custodial information of documents. As a result of the history update, the documents can be tagged in the case database 218 at block 704. At block 706, the document history database 216 can be updated. The processes can end at block 708.

FIG. 8 is a flow chart depicting illustrative processes for document history database 216 queries in accordance with one or more aspects of the present disclosure. The processes can begin at block 800. Initially, a user can make a request for document histories by entering in criteria, for example, a case number. At block 802, the server 200 can provide batch reviewing of documents. The history of each document can be displayed during navigation of those documents being searched for at block 804. The processes can end at block 806.

FIG. 9 is a flow chart depicting illustrative processes for removing production conflicts in accordance with one or more aspects of the present disclosure. The processes can begin at block 900. At block 902, the server 200 can query the document history database 216 for historical and custodial information. At block 904, the server 200 can eliminate conflicts within the case database 218 using that information found in the document history database 216. The processes can end at block 906.

FIG. 10 is a flow chart depicting illustrative processes for production history updates in accordance with one or more aspects of the present disclosure. The processes can begin at block 1000. At block 1002, production updates can be received. At block 1004, these updates can be sent to the document history database 216. The processes can end at block 1006.

Through the processes described in FIGS. 4 through 10, the entire litigation history can be managed through case identifications or other criteria. The workflow 300 described in FIG. 3, allows documents to be entered into the system 100. These documents can be reviewed multiple times in different litigation cases. With each of these updates, information can be stored within the document history database 216, which can work in tandem with the case database 218.

The workflow 300 can take into account of documents that are reviewed continuously by different custodians such as lawyers who read, make changes or evaluate the documents. By using this information from the custodian and the more times that a document is reviewed in separate instances, more value can be added to this system 100. The information about a document can be applied to new cases, thereby eliminating the need to be looked at again during the course of future litigation. As time goes on, the collection of documents that need review becomes smaller instead of larger, since the majority of those documents have been reviewed during the past and assessed as to their disposition.

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein can be implemented as logical operations and/or modules. The logical operations can be implemented as a sequence of processor-implemented executed steps and as interconnected machine or circuit modules. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A case management system comprising:
a database storing historical and custodial information of a plurality of documents through configurable hashes, wherein the configurable hashes are linked with the plurality of documents within a case database.

2. The case management system of claim 1, wherein the configurable hashes are hashed by a Message-Digest Algorithm 5 (MD5) or Secure Hash Algorithm 1 (SHA-1).

3. The case management system of claim 1, wherein the historical information comprises at least one of how the plurality of documents were ingested, tagged and produced.

4. The case management system of claim 1, wherein the custodial information is queried by the case type through at least one of case identification, tags by case identification and production by case identification.

5. The case management system of claim 1, wherein a document within the plurality of documents has at least two custodians.

6. The case management system of claim 1, wherein a document is received, hashed and compared with the configurable hashes stored within the database.

7. The case management system of claim 6, wherein the historical information for the document is updated when a hash for the document is found within the database otherwise, the historical information is created with a new hash for the document.

8. The case management system of claim 1, wherein the database provides at least one of batch reviews of the plurality of documents, displays the historical information during document navigation and production and redaction conflict identification.

9. A method for managing a plurality of documents through a historical database, the method comprising:
receiving a document;
creating a hash for the document;
searching for the hash within the historical database; and
updating custodial and historical information for the document within the historical database when the hash is found, otherwise, adding the hash into the historical database and associating the hash with the custodial and historical information.

10. The method of claim 9, comprising storing the document within a case database.

11. The method of claim 10, comprising linking the hash with the document within the case database.

12. The method of claim 9, wherein updating the hash comprises reflecting ingestion of the document.

13. The method of claim 9, wherein receiving the document comprises acquiring the document through a data load file import.

14. The method of claim 9, wherein receiving the document comprises acquiring the document through a native file ingestion.

15. The method of claim 9, comprising receiving a query for at least one document by case type.

16. The method of claim 9, comprising receiving a query for at least one document by case identification.

17. A case management server comprising:
at least one processor; and
a memory operatively coupled to the processor, the memory storing program instructions that when executed by the processor, causes the processor to:
store historical and custodial information for a plurality of documents within a historical database along with hashes of the plurality of documents;
store the plurality of documents within a case database;
link the hashes within the historical database to the plurality of documents within the case database.

18. The case management server of claim 17, wherein the historical information indicates how the plurality of documents have been at least one of ingested, tagged and produced.

19. The case management server of claim 17, wherein the custodial information is through at least one of case identification, tags by case identification and production by case identification.

20. The case management server of claim 17, wherein the memory operatively coupled to the processor, when executed, causes the processor to receive the plurality of documents through native file ingestion or data load file import.
